(19) United States
(12) Patent Application Publication
(10) Pub. No.: US 2004/0017750 A1
(43) Pub. Date: Jan. 29, 2004

(54) Method and apparatus for calibrating laser write power for writing data onto an optical storage medium

(75) Inventors: Ching-Chuan Hsu, Hsinchu Hsien (TW); Ming-Yang Chao, Hsinchu Hsien (TW)

Correspondence Address: BRINKS HOFER GILSON & LIONE, NBC Tower, Suite 3600, 455 N. Cityfront Plaza Drive, Chicago, IL, 60611-5599, US

(73) Assignee: MEDIA TEK INC.

(21) Appl. No.: 10/389,370

(22) Filed: Mar. 14, 2003

(30) Foreign Application Priority Data
Jul. 25, 2002 (TW) 091116622

(51) Int. Cl. G11B 7/00

(52) U.S. Cl. 369/47.53; 369/53.34

(57) ABSTRACT

In method and apparatus for calibrating laser write power for writing data onto an optical storage medium, test data is written onto a test area of the optical storage medium at a number (N) of laser power levels. The test data written onto the test area is read and processed so as to generate a number (N) of processed signals corresponding to the number (N) of laser power levels, respectively. A jitter value associated with each of the processed signals is determined. Finally, one of the laser power levels that corresponds to one of the processed signals having the jitter value that is at a relative minimum is selected. The laser write power is set to the selected one of the laser power levels.

### CROSS-REFERENCE TO RELATED APPLICATION

This application claims priority of Taiwanese Patent Application No. 091116622, filed on Jul. 25, 2002.

### BACKGROUND OF THE INVENTION

1. Field of the Invention

The invention relates to anoptical recording system, more particularly to a method and apparatus for calibrating laser write power for writing data onto an optical storage medium.

2. Description of the Related Art

In a conventional optical recording system, such as a rewritable optical disk drive, data is written onto an optical storage medium, such as a compact disc-recordable (CD-R), a digital video disc-recordable (DVD-R), a compact disc-rewritable (CD-RW) or a magneto-optical disc, by an optical pick-up at a laser write power. Due to the differences in different kinds of optical storage mediums and spin speeds thereof, it is important to calibrate the optimal laser write power for writing data onto each kind of optical storage media.

Conventionally, Beta (β) and Gamma (γ) values, which can be obtained in a power range as a function of laser write power, are used to determine of an optimal laser write power.

### SUMMARY OF THE INVENTION

The object of the present invention is to provide a method and apparatus for calibrating laser write power for writing data onto an optical storage medium that utilize a jitter meter.

According to one aspect of the present invention, there is provided a method of calibrating laser write power for writing data onto an optical storage medium. The method comprises the steps of:

(a) writing test data onto a test area of the optical storage medium at a number (N) of laser power levels;

(b) reading and processing the test data written onto the test area so as to generate a number (N) of processed signals corresponding to the number (N) of laser power levels, respectively;

(c) determining a jitter value associated with each of the processed signals; and

(d) selecting one of the laser power levels that corresponds to one of the processed signals having the jitter value that is at a relative minimum, and setting the laser write power to the selected one of the laser power levels.

According to another aspect of the present invention, an apparatus is adapted for calibrating laser write power when writing data onto an optical storage medium, and comprises:

means for writing test data onto a test area of the optical storage medium at a number (N) of laser power levels;

means for reading and processing the test data written onto the test area so as to generate a number (N) of processed signals corresponding to the number (N) of laser power levels, respectively;

means for determining a jitter value associated with each of the processed signals; and

means for selecting one of the laser power levels that corresponds to one of the processed signals having the jitter value that is at a relative minimum, and for setting the laser write power to the selected one of the laser power levels.

According to a further aspect of the present invention, an optical recording system is adapted for writing data onto an optical storage medium, and comprises:

an optical pick-up;

a controller coupled electrically to the optical pick-up for controlling the optical pick-up to read data from and write data onto the optical storage medium, the controller generating write power control signals corresponding respectively to a number (N) of laser power levels to the optical pick-up so as to control the optical pick-up to write test data onto a test area of the optical storage medium at each of the number (N) of laser power levels, the controller further controlling the optical pick-up to read the test data written onto the test area;

a processing unit coupled electrically to the optical pick-up for processing the test data read back from the test area so as to generate a number (N) of processed signals corresponding to the number (N) of laser power levels, respectively; and

a jitter meter coupled electrically to the processing unit for determining a jitter value associated with each of the processed signals;

the controller being coupled electrically to the jitter meter and selecting one of the laser power levels that corresponds to one of the processed signals having the jitter value that is at a relative minimum, the controller setting laser write power for writing data onto the optical storage medium to the selected one of the laser power levels.

### BRIEF DESCRIPTION OF THE DRAWINGS

Other features and advantages of the present invention will be come apparent in the following detailed description of the preferred embodiment with reference to the accompanying drawings, of which:

FIG. 1 is a schematic circuit block diagram illustrating the preferred embodiment of an optical recording system according to the present invention;

FIG. 2A and 2B are flow charts illustrating how the preferred embodiment is configured to calibrate laser write power for writing data onto an optical storage medium;

FIGS. 3A to 3F are timing diagrams of a read control signal (Tr), a power-change-index control signal (Tp), a power-stable signal (Ps), a measuring control signal (Tm), a storing control signal (Ts), and a jitter-value generating signal (Tv); and

FIG. 4 is a plot illustrating the jitter values, which correspond to laser power levels, respectively, obtained by the preferred embodiment.

### DETAILED DESCRIPTION OF THE PREFERRED EMBODIMENT

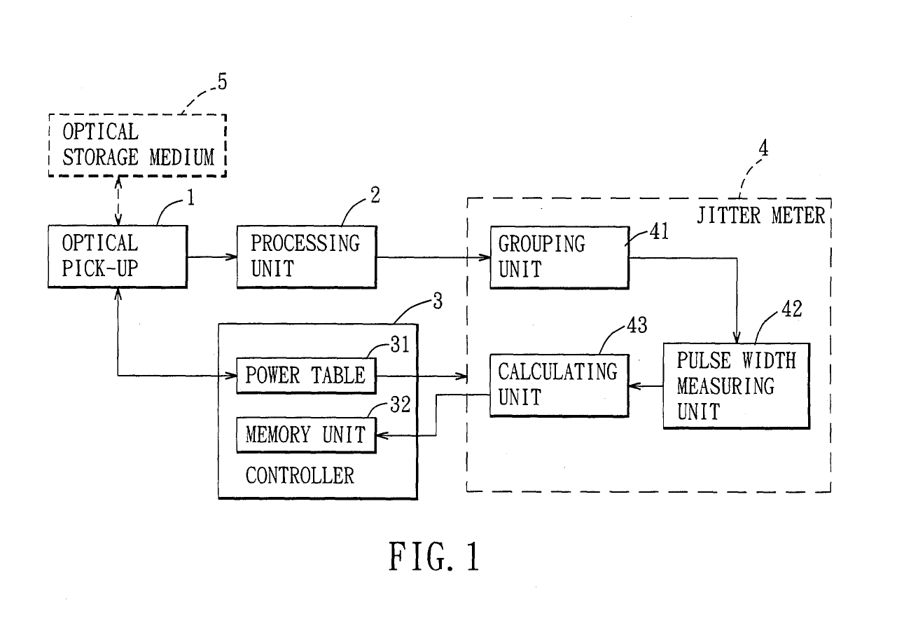

Referring to FIG. 1, the preferred embodiment of an optical recording system, such as an optical rewritable disk drive, for writing data onto an optical storage medium 5, such as a CD-R, a DVD-R, a CD-RW or a magneto-optical disc, according to the present invention is shown to include an optical pick-up 1, a controller 3, a processing unit 2, and a jitter meter 4.

The controller 3 is coupled electrically to the optical pick-up 1 for controlling the optical pick-up 1 to read data from and write data on to the optical storage medium 5. The controller 3 generates write power control signals corresponding respectively to a number (N) of laser power levels to the optical pick-up 1 so as to control the optical pick-up 1 to write test data onto a test area of the optical storage medium 5 at each of the number (N) of laser power levels. The controller 3 further controls the optical pick-up 1 to read the test data written onto the test area. The controller 3 includes a power table 31 pre-recorded with the laser power levels for writing the test data. In this embodiment, each of the number (N) of laser power levels is within a predetermined power range. Preferably, the laser power levels are evenly distributed between minimum and maximum power limits (Pmin, Pmax) of the predetermined power range. As such, the laser power levels are Pmin, Pmin+(Pmax−Pmin)/N−1, Pmin+2×(Pmax−Pmin)/N−1, . . . , Pmin+(N−2)×(Pmax−Pmin)/N−1, Pmax.

The processing unit 2 is coupled electrically to the optical pick-up 1 for processing the test data read back from the test area so as to generate a number (N) of processed signals corresponding to the number (N) of laser power levels, respectively. It is noted that the test data read back from the test area includes analog signals, such as radio frequency signals, that are digitized and sliced by the processing unit 2 in a conventional manner to result in the processed signals, which are digital signals.

The jitter meter 4 is coupled electrically to the processing unit 2 for determining a jitter value (Vn) associated with each of the processed signals. The jitter meter 4 includes a grouping unit 41, a pulse width measuring unit 42, and a calculating unit 43. The grouping unit 41 is coupled electrically to the processing unit 2 for grouping each of the processed signals into a number (k) of moving patterns with a pattern length. In this embodiment, the pattern length of the processed signals ranges from three to eleven times are reference clock. The pulse width measuring unit 42 is coupled electrically to the grouping unit 41 for measuring a pulse width (L(k)) of each of the moving patterns. The calculating unit 43 is coupled electrically to the pulse width measuting unit 42 for obtaining a moving average width (A(k) ) associated with each of the processed signals based on the pulse widths (L(k)) of the moving patterns therein, that is,

A(k−1)=(1/M)×L(k−1)+[(M−1)/M]×A(k=2) (Equation 1)

where A(k−1) represents the moving average width of a first moving pattern to a (k−1)^{th} moving pattern, L(k−1) represents the pulse width of a (k−1)^{th} moving pattern, A(k−2) represents the moving average width of the first moving pattern to the (k−2)^{th} moving pattern, and 1/M and (M−1)/M represent weighting values. In this embodiment, M can be set to 256. The number (k) is in direct proportion to the amount of the test data, and is much greater than M. The calculating unit 43 can thus obtain the jitter value (Vn), which is a moving average value such that it can be expressed as V(k), for each of the processed signals based on deviation between the moving average width (A(k)) and the pulse width (L(k)) of each of the moving patterns therein, that is,

V(k)=(1/M)×(L(k)−A(k−1) )+[(M−1)/M]×V(k−1) (Equation 2)

where L(k) represents the pulse width of a k^{th} moving pattern, and V(k−1) represents the jitter value of a first moving pattern to a (k−1)^{th} moving pattern.

The controller 3 is coupled electrically to the jitter meter 4 such that the calculating unit 43 provides the jitter values (Vn, n=1,2, . . . , N) calculated thereby to the controller 3. The controller 3 includes a memory unit 32 coupled electrically to the calculating unit 43 for storing the jitter values (Vn) calculated by the calculating unit 43 therein. As such, the controller 3 selects one of the laser power levels that corresponds to one of the processed signals having the jitter value (Vn) that is at a relative minimum among those stored in the memory unit 32. The controller 3 subsequently sets the laser write power for writing data onto the optical storage medium 5 to the selected one of the laser power levels. Optimal power calibration for the optical recording system is completed accordingly.

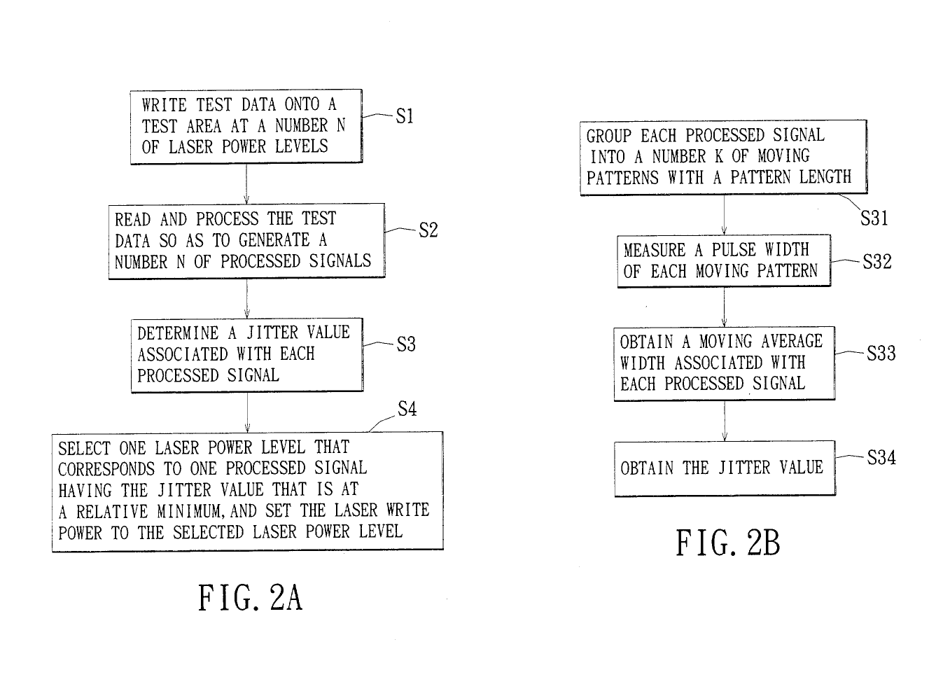

Referring to FIGS. 2A and 2B, there are shown flow charts to illustrate how the optical recording system of this invention is configured to calibrate laser write power for writing data onto the optical storage medium 5. In step S1, the controller 3 enables the optical pick-up 1 to write the test data onto the test area of the optical storage medium 5 at the number (N) of laser power levels that are pre-recorded in the power table 31. In step S2, the controller 3 enables the optical pick-up 1 to read the test data written onto the test area of the optical storage medium 5 and to provide the data to the processing unit 2 according to a power-stable signal (Ps) that results from a read control signal (Tr) and a power-change-index control signal (Tp) generated by the controller 3. The processing unit 2 processes the test data read by the optical pick-up 1 so as to generate the number (N) of processed signals corresponding to the number (N) of laser power levels, respectively. In step S3, the jitter meter 4 determines the jitter value (Vn) associated with each of the processed signals. In step S31, the grouping unit 41 groups each of the processed signals into the number (k) of moving patterns with a pattern length. Preferably, each of the moving patterns has the pattern length equal to three times the reference clocks, i.e., 3T. In step S32, the pulse width measuring unit 42 measures the pulse width (L(k)) of each of the moving patterns according to a measuring control signal (Tm) generated by the controller 3. In step S33, the calculating unit 43 obtains the moving average width (A(k)) associated with each of the processed signals based on the pulse widths (L(k)) of the moving patterns therein according to the measuring control signal (Tm). In step S34, the calculating unit 43 calculates the jitter value (Vn) for each of the processed signals based on deviation between the moving average width (A(k)) and the pulse width (L(k)) of each of the moving patterns therein according to the measuring control signal (Tm). The jitter values (Vn) calculated by the calculating unit 43 are transmitted to the controller 3 and are stored into the memory unit 32 according to a storing control signal (Ts) generated by the controller 3. In step S4, the controller 3 selects one of the laser power levels that corresponds to one of the processed signals having the jitter value (Vn) that is at a relative minimum, and sets the laser write power to the selected one of the laser power levels.

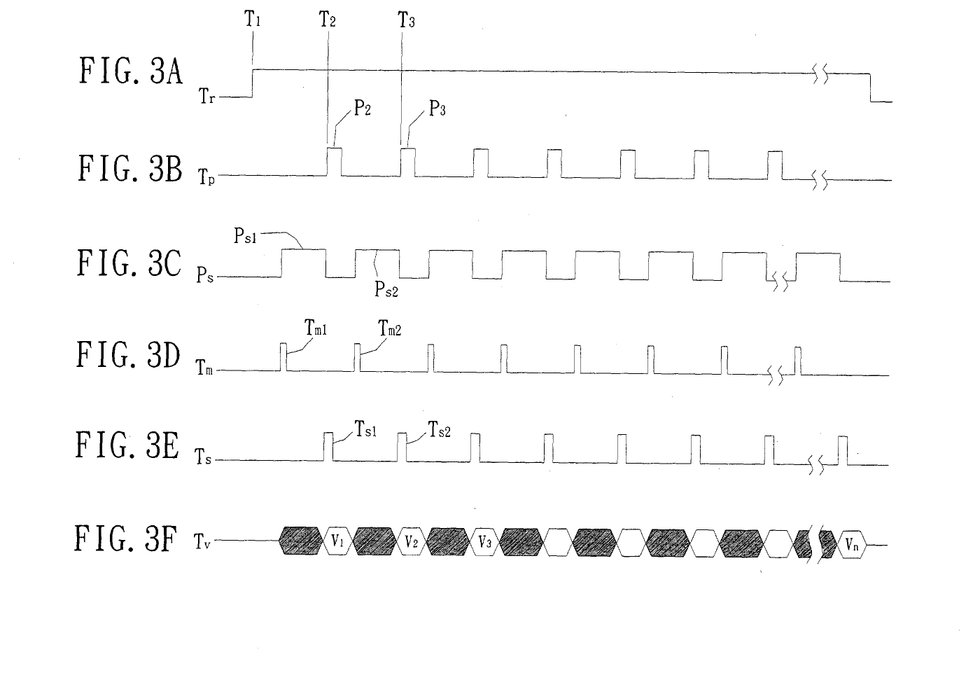

FIGS. 3A to 3F illustrate timing control of the read control signal (Tr), the power-change-index control signal (Tp), the power-stable signal (Ps), the measuring control signal (Tm), the storing control signal (Ts), and the jitter-value generating signal (Tv) When the read control signal (Tr) becomes high level at T1, the controller 3 outputs the laser power level of Pmin so as to enable the optical pick-up 1 to read the test data written onto the test area once the power-stable signal (Ps) presents a pulse (Ps1) such that the jitter meter 4 begins to calculate the jitter value (V₁) when the measuring control signal (Tm) presents a pulse (Tm1) and such that the controller 3 stores the jitter value (V₁) in the memory unit 32 when the storing control signal (Ts) presents a pulse (Ts1). Then, when the power-change-index signal (Tp) presents a pulse (P2) at T2 while the read control signal (Tr) still holds the high level, the controller 3 outputs a laser read power that is much smaller than the laser power level of Pmin so as to enable the optical pick-up 1 to read the test data written onto the test area once the power-stable signal (Ps) presents a pulse (Ps2) such that the jitter meter 4 begins to calculate the jitter value (V₂) when the measuring control signal (Tm) presents a pulse (Tm2) and such that the controller 3 stores the jitter value (V₂) in the memory unit 32 when the storing control signal (Ts) presents a pulse (Ts2). As such, according to the aforesaid timing control, the jitter values (V₁, . . . , Vₙ) associated with the processed signals can be obtained.

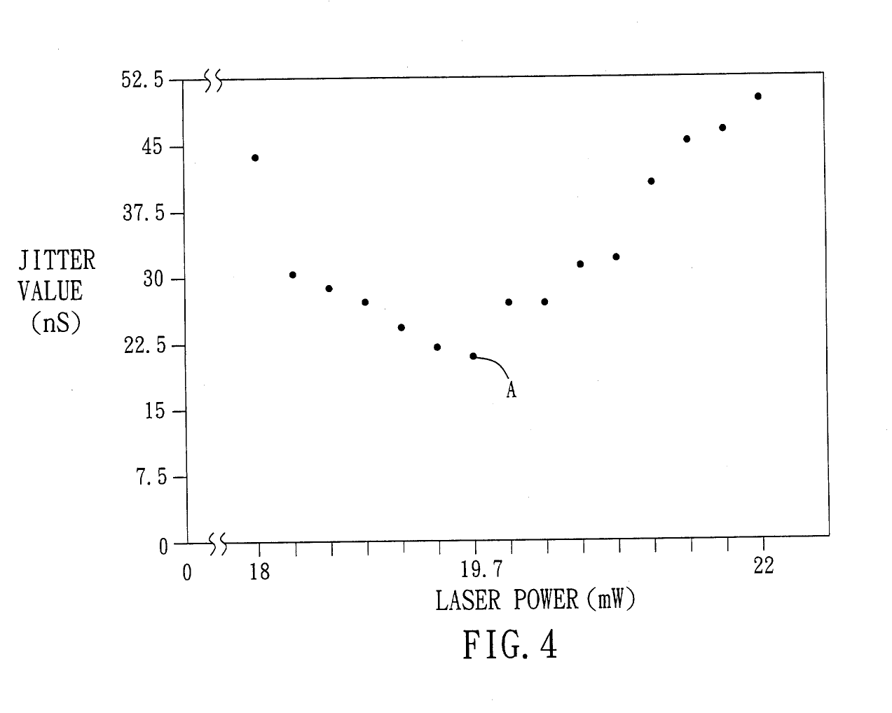

FIG. 4 illustrates an example of optimal power calibration obtained by the optical recording system of this invention. In this example, there are provided 15 laser power levels within 18 mW to 22 mW. Since the jitter value indicated by a dot (A) is at a relative minimum, a corresponding laser power approximately equal to 19.7 mW is determined to be an optimal laser write power.

It is noted that, due to the presence of the jitter meter 4, the jitter values determined by the optical recording system of this invention directly relate to characteristics of the processed signals. Therefore, complicated measurement of β and γ values and decision of optimal β and γ values as required in the prior art can be omitted.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of calibrating laser write power for writing data onto an optical storage medium, comprising the steps of:
(a) writing test data onto a test area of the optical storage medium at a number (N) of laser power levels;
(b) reading and processing the test data written onto the test area so as to generate a number (N) of processed signals corresponding to the number (N) of laser power levels, respectively;
(c) determining a jitter value associated with each of the processed signals; and
(d) selecting one of the laser power levels that corresponds to one of the processed signals having the jitter value that is at a relative minimum, and setting the laser write power to the selected one of the laser power levels.

2. The method as claimed in claim 1, wherein the laser power levels for writing the test data are pre-recorded in a power table.

3. The method as claimed in claim 1, wherein each of the number (N) of laser power levels is within a predetermined power range.

4. The method as claimed in claim 2, wherein the laser power levels are evenly distributed between minimum and maximum power limits of the predetermined power range.

5. The method as claimed in claim 1, wherein the test data read back from the test area includes analog signals that are digitized and sliced to result in the processed signals.

6. The method as claimed in claim 1, wherein step (c) includes the sub-steps of:
(c-1) grouping each of the processed signals into a number (k) of moving patterns with a pattern length;
(c-2) measuring a pulse width of each of the moving patterns;
(c-3) obtaining a moving average width associated with each of the processed signals based on the pulse widths of the moving patterns therein; and
(c-4) obtaining the jitter value, which is a moving average value, for each of the processed signals based on deviation between the moving average width and the pulse width of each of the moving patterns therein.

7. The method as claimed in claim 6, wherein the pattern length of the moving patterns in each of the processed signals ranges from three to eleven times a reference clock.

8. An apparatus for calibrating laser write power when writing data onto an optical storage medium, comprising:
means for writing test data onto a test area of the optical storage medium at a number (N) of laser power levels;
means for reading and processing the test data written onto the test area so as to generate a number (N) of processed signals corresponding to the number (N) of laser power levels, respectively;
means for determining a jitter value associated with each of the processed signals; and
means for selecting one of the laser power levels that corresponds to one of the processed signals having the jitter value that is at a relative minimum, and for setting the laser write power to the selected one of the laser power levels.

9. The apparatus as claimed in claim 8, wherein said means for writing the test data includes a power table pre-recorded with the laser power levels for writing the test data.

10. The apparatus as claimed in claim 8, wherein each of the number (N) of laser power levels is within a predetermined power range.

11. The apparatus as claimed in claim 10, wherein the laser power levels are evenly distributed between minimum and maximum power limits of the predetermined power range.

12. The apparatus as claimed in claim 8, wherein the test data read back from the test area includes analog signals that are digitized and sliced by said means for reading and processing the test data to result in the processed signals.

13. The apparatus as claimed in claim 8, wherein said means for determining the jitter value includes:
means for grouping each of the processed signals into a number (k) of moving patterns with a pattern length;
means for measuring a pulse width of each of the moving patterns;
means for obtaining a moving average width associated with each of the processed signals based on the pulse widths of the moving patterns therein; and
means for obtaining the jitter value, which is a moving average value, for each of the processed signals based on deviation between the moving average width and the pulse width of each of the moving patterns therein.

14. The apparatus as claimed in claim 13, wherein the pattern length of the moving patterns in each of the processed signals ranges from three to eleven times a reference clock.

15. An optical recording system for writing data onto an optical storage medium, comprising:
an optical pick-up;
a controller coupled electrically to said optical pick-up for controlling said optical pick-up to read data from and write data onto the optical storage medium, said controller generating write power control signals corresponding respectively to a number (N) of laser power levels to said optical pick-up so as to control said optical pick-up to write test data onto a test area of the optical storage medium at each of the number (N) of laser power levels, said controller further controlling said optical pick-up to read the test data written onto the test area;
a processing unit coupled electrically to said optical pick-up for processing the test data read back from the test area so as to generate a number (N) of processed signals corresponding to the number (N) of laser power levels, respectively; and
a jitter meter coupled electrically to said processing unit for determining a jitter value associated with each of the processed signals;
said controller being coupled electrically to said jitter meter and selecting one of the laser power levels that corresponds to one of the processed signals having the jitter value that is at a relative minimum, said controller setting laser write power for writing data onto the optical storage medium to the selected one of the laser power levels.

16. The optical recording system as claimed in claim 15, wherein said controller includes a power table pre-recorded with the laser power levels for writing the test data.

17. The optical recording system as claimed in claim 15, wherein each of the number (N) of laser power levels is within a predetermined power range.

18. The optical recording system as claimed in claim 17, where in the laser power levels are evenly distributed between minimum and maximum power limits of the predetermined power range.

19. The optical recording system as claimed in claim 15, wherein the test data read back from the test area includes analog signals that are digitized and sliced by said processing unit to result in the processed signals.

20. The optical recording system as claimed in claim 15, wherein said jitter meter includes:
a grouping unit coupled electrically to said processing unit for grouping each of the processed signals into a number (k) of moving patterns with a pattern length;
a pulse width measuring unit coupled electrically to said grouping unit for measuring a pulse width of each of the moving patterns; and
a calculating unit coupled electrically to said pulse width measuring unit for obtaining a moving average width associated with each of the processed signals based on the pulse widths of the moving patterns therein;
said calculating unit obtaining the jitter value, which is a moving average value, for each of the processed signals based on deviation between the moving average width and the pulse width of each of the moving patterns therein;
said calculating unit providing the jitter values calculated thereby to said controller.

21. The optical recording system as claimed in claim 20, wherein said controller includes a memory unit coupled electrically to said calculating unit for storing the jitter values calculated by said calculating unit therein, said controller selecting said one of the laser power levels that corresponds to said one of the processed signals having the jitter value that is at the relative minimum among those stored in said memory unit.

22. The apparatus as claimed in claim 20, wherein the pattern length of the moving patterns in each of the processed signals ranges from three to eleven times a reference clock.
